(19) United States
(12) Patent Application Publication
(10) Pub. No.: US 2024/0142251 A1
(43) Pub. Date: May 2, 2024

(54) INFORMATION PROCESSING METHOD

(71) Applicant: TOYOTA JIDOSHA KABUSHIKI KAISHA, Toyota-shi (JP)

(72) Inventors: Motohiro NAKAMURA, Okazaki-shi (JP); Toshiki KASHIWAKURA, Tokyo-to (JP); Yosuke TOGAMI, Nagoya-shi (JP); Yusuke KOBAYASHI, Tokyo-to (JP); Seii SAI, Yokohama-shi (JP); Tsuyoshi OKADA, Nagoya-shi (JP); Naoko YOKOYAMA, Tokyo-to (JP); Keishi KINOSHITA, Tokyo-to (JP)

(73) Assignee: TOYOTA JIDOSHA KABUSHIKI KAISHA, Toyota-shi (JP)

(21) Appl. No.: 18/493,810

(22) Filed: Oct. 25, 2023

(30) Foreign Application Priority Data
Nov. 1, 2022 (JP) 2022-175747

(51) Int. Cl. G01C 21/34; G06Q 10/0835

(52) U.S. Cl. CPC G01C 21/3484; G01C 21/343; G06Q 10/08355

(57) ABSTRACT

An information processing method performed by an information processing apparatus includes acquiring route information that indicates a route or a stop position for a delivery vehicle, the route information being generated based on driver information regarding a driver of the delivery vehicle and delivery information regarding a package to be delivered by the delivery vehicle.

### CROSS-REFERENCE TO RELATED APPLICATION

This application claims priority to Japanese Patent Application No. 2022-175747, filed on Nov. 1, 2022, the entire contents of which are incorporated herein by reference.

### TECHNICAL FIELD

This disclosure relates to an information processing method that provides route information suitable for a driver of a vehicle.

### BACKGROUND

Apparatuses that provide route information according to vehicle classification are known (see, for example, Patent Literature (PTL) 1).

### CITATION LIST

### Patent Literature

PTL 1: JP 2019-139644 A

### SUMMARY

It is required to provide route information suitable for drivers.

It would be helpful to provide route information suitable for drivers.

An information processing method according to an embodiment of the present disclosure is an information processing method performed by an information processing apparatus, the information processing method including acquiring route information that indicates a route or a stop position for a delivery vehicle, the route information being generated based on driver information regarding a driver of the delivery vehicle and delivery information regarding a package to be delivered by the delivery vehicle.

According to the information processing method of an embodiment of the present disclosure, route information suitable for drivers can be provided.

### BRIEF DESCRIPTION OF THE DRAWINGS

In the accompanying drawings:

FIG. 1 is a block diagram illustrating an example configuration of an information processing system according to an embodiment; and

FIG. 2 is a flowchart illustrating an example procedure for an information processing method according to an embodiment.

### DETAILED DESCRIPTION

### Example Configuration of Information Processing System 1

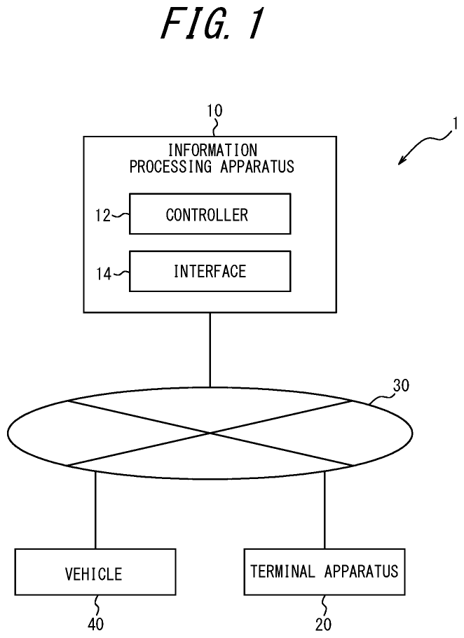

As illustrated in FIG. 1, an information processing system 1 according to an embodiment of the present disclosure includes an information processing apparatus 10 and a vehicle 40. The vehicle 40 carries packages to be delivered. The vehicle 40 that carries the packages to be delivered is also referred to as delivery vehicle. The information processing apparatus 10 manages operations of the vehicle 40 so as to increase the efficiency of delivery of the packages. The information processing apparatus 10 generates information that indicates a route or stop positions for the vehicle 40. The information processing apparatus 10 may generate the information that indicates the route or the stop positions for the vehicle 40 so as to increase the efficiency of delivery of the package. The information that indicates the route or the stop positions for the vehicle 40 is also referred to as route information.

The information processing system 1 further includes, but is not required to include, a terminal apparatus 20. The terminal apparatus 20 may be mounted in the vehicle 40 or may be carried by a driver of the vehicle 40. The terminal apparatus 20 may be configured to output the route information generated by the information processing apparatus 10 and notify the driver of the route information. An example configuration of the information processing system 1 will be described below.

<Information Processing Apparatus 10>

The information processing apparatus 10 includes a controller 12 and an interface 14.

The controller 12 controls at least one component of the information processing apparatus 10. The controller 12 may be configured to include at least one processor. The “processor” may include a general purpose processor, a dedicated processor specialized for specific processing, or the like in the present embodiment, but not limited to these. The controller 12 may be configured to include at least one dedicated circuit. The dedicated circuit may include, for example, a field-programmable gate array (FPGA) or an application specific integrated circuit (ASIC). The controller 12 may be configured with the dedicated circuit instead of the processor, or may be configured with the dedicated circuit along with the processor.

The information processing apparatus 10 may further include a memory. The memory is a semiconductor memory, a magnetic memory, an optical memory, or the like, for example, but not limited to these. The memory may function, for example, as a main memory, an auxiliary memory, or a cache memory. The memory may include an electromagnetic storage medium, such as a magnetic disk. The memory may include a non-transitory computer readable medium. The memory stores any information to be used for operations of the information processing apparatus 10. For example, the memory may store a system program, an application program, or the like. The memory may be included in the controller 12.

The interface 14 outputs information, data, or the like from the controller 12 to an external apparatus, and inputs information, data, or the like acquired from the external apparatus to the controller 12. The interface 14 may include a communication module that is configured communicably with the external apparatus, such as the vehicle 40 or the terminal apparatus 20, via a network 30. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The interface 14 may be configured to be able to connect to a communication module.

The interface 14 may be configured with an input device for accepting input of information, data, or the like from a user. The input device may be configured with, for example, a touch panel, a touch sensor, or a pointing device such as a mouse. The input device may be configured with a physical key. The input device may be configured with an audio input device, such as a microphone.

The interface 14 may be configured to include an output device that outputs information, data, or the like to the user. The output device may include, for example, a display device that outputs visual information, such as images, letters, or graphics. The display device may be configured with, for example, a Liquid Crystal Display (LCD), an organic or inorganic Electro-Luminescence (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, an audio output device, such as a speaker that outputs audio information, such as voice. The output device is not limited to the above examples and may include various other devices.

The information processing apparatus 10 may include a single server apparatus or a plurality of server apparatuses capable of communicating with each other.

<Vehicle 40>

The vehicle 40 includes a vehicle body and a drive unit. The vehicle 40 is configured to load, into the vehicle body, articles to be delivered. The vehicle 40 may further include a controller that controls the drive unit. The vehicle 40 may further include a positional information detector that acquires positional information on the vehicle 40 itself. The vehicle 40 may output the positional information on the vehicle 40 itself to the information processing apparatus 10. The positional information detector may be configured to include a receiver compliant with a satellite positioning system. The receiver compliant with the satellite positioning system may include, for example, a Global Positioning System (GPS) receiver.

The number of vehicles 40 managed by the information processing system 1 may be two or more. The vehicle 40 is configured to be driven by a driver. The vehicle 40 may include an in-vehicle apparatus, such as a navigation apparatus, that acquires the route information from the information processing apparatus 10 and notifies the driver of the route information. The vehicle 40 may notify the driver of the route information with the terminal apparatus 20 described below.

<Terminal Apparatus 20>

The terminal apparatus 20 may be configured to include one or more processors or one or more dedicated circuits. The terminal apparatus 20 may be configured to include a memory. The memory of the terminal apparatus 20 may be configured to be identical or similar to the memory of the information processing apparatus 10. The terminal apparatus 20 may be configured to include an interface or a communication module. The interface or communication module of the terminal apparatus 20 may be configured to be identical or similar to the interface or communication module of the information processing apparatus 10, respectively.

The terminal apparatus 20 may be configured to include an input device that accepts input of information, data, or the like from a user. The input device may be configured to include the various devices described as the interface 14. The terminal apparatus 20 may be configured to include an output device that outputs information, data, or the like to the user. The output device may be configured to include the various devices described as the interface 14.

The number of terminal apparatuses 20 included in the information processing system 1 is not limited to one and may be two or more. The terminal apparatus 20 may be configured as a mobile terminal such as a smartphone or a tablet, or a Personal Computer (PC) such as a notebook PC or a tablet PC. The terminal apparatus 20 is not limited to the above examples and may be configured to include various devices.

### Example Operations of Information Processing System 1

In the information processing system 1 according to the present embodiment, the controller 12 of the information processing apparatus 10 generates, based on driver information regarding the driver of the delivery vehicle and delivery information regarding the packages to be delivered by the delivery vehicle, the route information that indicates the route or the stop positions for the delivery vehicle.

### Example of Delivery Information

The delivery information may include information identifying delivery destinations of the packages. The delivery information may include information identifying times or time periods specified as delivery times of the packages. The delivery information may include information identifying whether the packages are refrigerated or frozen, whether each package is fragile, or the like. The delivery information may include information specifying whether a hand delivery is required or a package drop is accepted.

### Example of Driver Information

The driver information may include, for example, the number of years of experience the driver has had in delivery work. The driver information may include information identifying whether the driver is experienced or new. For example, the driver may be identified as being experienced when the driver has a predetermined number of years of experience or more. The predetermined number of years to identify whether the driver is experienced may be set to various values, such as 3 or 5 years. For example, the driver may be identified as being new when the driver has less than a predetermined number of years of experience. The predetermined number of years to identify whether the driver is new may be set to various values, such as 1 year, 0.5 years (6 months), or 0.25 years (3 months).

The driver information may include information representing the delivery work characteristics of the driver. The delivery work characteristics of the driver may include, for example, information identifying efficiency with which the driver delivers packages. The efficiency with which the driver delivers packages can be identified, for example, by the number of packages the driver can deliver per unit time, or the number of delivery destinations the driver can visit per unit time, the extent to which the driver can deliver per unit time, or the like. The unit time may be set to various values, for example, one hour. The controller 12 may calculate, as a numerical value, the efficiency with which the driver delivers packages. When the numerical value representing the delivery efficiency of the driver is greater than or equal to a predetermined value, the driver may be identified as an advanced driver. When the numerical value representing the delivery efficiency of the driver is less than a predetermined value, the driver may be identified as a novice driver. Based on the numerical value representing the delivery efficiency of the driver, the driver may be ranked.

The controller 12 may calculate, as the delivery work characteristics of the driver, the difference between an average delivery work and a delivery work performance of the driver. The average delivery work is also referred to as average work. The controller 12 may acquire a value representing the delivery efficiency of each of multiple drivers. The controller 12 may calculate the average of the values representing the delivery efficiency of the drivers, as a value representing the average work. The controller 12 may calculate, as a value representing the delivery work characteristics of a target driver, the difference between the value representing the average work and a value representing the delivery efficiency of the target driver whose delivery work characteristic is to be calculated.

The controller 12 may acquire, as a numerical value representing the delivery work characteristics, travel time to the delivery destinations or the fuel efficiency of the delivery vehicle, for example. The controller 12 may acquire, as the delivery work characteristics, the conditions of the packages to be delivered, for example. When the packages to be delivered are deformed or dirty, the controller 12 may determine that the driver has poor delivery work characteristics. The controller 12 may acquire, as the delivery work characteristics, ratings from users who receive delivery of the packages or users who request delivery of the packages. The controller 12 may acquire, as the delivery work characteristics, ratings from third parties, such as passersby or residents around locations where the delivery vehicle is parked at the delivery destinations. The ratings from the users or the third parties may include opinions of satisfaction with the delivery work, dissatisfaction felt with the delivery work, or the like.

The controller 12 may statistically process numerical values representing the delivery work characteristics of each of the multiple drivers. The controller 12 may calculate a deviation of the delivery work characteristics of a target driver by assuming that the values representing the delivery work characteristics of the multiple drivers follow a normal distribution.

The delivery work characteristics of the driver may include information representing a skill with which the driver drives the delivery vehicle. The skill of driving the delivery vehicle may include, for example, information on roads on which the driver can drive the delivery vehicle, or information on stop positions at which the driver can stop the delivery vehicle with reduced impact on surrounding traffic.

<Generation of Route Information Based on Driver Information and Delivery Information>

Based on the driver information and the delivery information, the controller 12 may generate the route information that indicates the route along which the driver drives the delivery vehicle or the stop positions for the delivery vehicle when the driver delivers the packages. By generating the route information based on the driver information, a route suitable for each driver can be presented. By presenting the route suitable for each driver, the travel of the vehicle 40 can be stabilized. In addition, the fuel efficiency of the vehicle 40 can be enhanced. In addition, the overall driving efficiency of the vehicle 40 can be enhanced. As a result, the overall efficiency of the delivery work can be increased.

The controller 12 may generate the route information so as to improve the delivery work characteristics of the driver. For example, the controller 12 may generate the route information so as to enhance the delivery efficiency of the driver. The controller 12 may generate, based on the skill with which the driver drives the delivery vehicle, the route information that indicates the route of the delivery vehicle so as to reduce the travel time of the delivery vehicle to the delivery destinations. The controller 12 may generate the route information that indicates the stop positions for the delivery vehicle so as to reduce time to stop the delivery vehicle at the delivery destinations and deliver the packages. By generating the route information so as to improve the delivery work characteristics of the driver, the overall efficiency of the delivery work can be increased.

In a case in which the delivery work performance of the driver is below the average work due to the driver's skill in driving the delivery vehicle, the controller 12 may generate the route information so as to enhance the driver's skill in driving the delivery vehicle. For example, the controller 12 may generate the route information that indicates a route that provides experience to increase the number of roads on which the driver can drive the delivery vehicle. For example, the controller 12 may generate the route information that indicates stop positions at which the driver can experience stopping so that the driver can enhance a skill in stopping the delivery vehicle. The enhancement of the driver's skill can improve the delivery work characteristics of the driver. The improvement in the delivery work characteristics of the driver can enhance the efficiency of the delivery work.

The controller 12 may generate the route information using a learned model that outputs the route information by inputting the driver information and the delivery information. The controller 12 may generate the learned model by learning using routes or stop positions of drivers driving delivery vehicles, as training data. The controller 12 may acquire the learned model from an external apparatus. The controller 12 may input the driver information and the delivery information to the learned model running on an external apparatus, and acquire the route information generated by the learned model on the external apparatus.

The controller 12 may generate the route information so as to impart the know-how of high-skilled drivers such as experienced drivers to low-skilled drivers such as new drivers. The low-skilled drivers may not be able to drive the delivery vehicle according to the route information that includes the know-how of the high-skilled drivers. The controller 12 may generate the route information that includes the know-how of drivers at levels that are feasible for the low-skilled drivers. The learned model that outputs the route information may be configured to output the route information suitable for the level of a target driver to whom the route information is notified. By generating the route information suitable for the level of the driver, the number of drivers who cannot drive according to the route information can be reduced. By allowing each driver to drive according to the route information, a burden on each driver can be reduced. By reducing the burden on each driver, the retention rate of drivers can be enhanced. As a result, the overall efficiency of the delivery work can be increased.

The controller 12 may generate, as the route information, points on which the high-skilled drivers focus when determining routes and stop positions for delivery based on the delivery information. The controller 12 may generate, as the route information, the selection of a lane or the timing of changing lanes when the high-skilled drivers drive delivery vehicles, for example. The low-skilled drivers may have difficulty in driving in the same lane as the high-skilled drivers. The low-skilled drivers may have difficulty in changing lanes at the same timing as the high-skilled drivers. The controller 12 may generate the route information that indicates the selection of a lane or the timing of changing lanes that is feasible for the low-skilled drivers. In addition, the high-skilled drivers can change driving details according to road conditions such as traffic. On the other hand, the low-skilled drivers may not be able to change driving details according to the road conditions. The controller 12 may generate the route information that encourages the driver to change driving details according to the road conditions such as traffic.

The controller 12 may calculate an average route or average stop positions based on travel routes or stop positions of multiple delivery vehicles. The controller 12 may extract the characteristics of travel routes or stop positions selected by the high-skilled drivers, based on comparisons between the travel routes or the stop positions of the high-skilled drivers and the average route or the average stop positions. The controller 12 may determine whether the extracted characteristics contribute to enhancement of delivery efficiency. In a case in which the extracted characteristics contribute to enhancement of delivery efficiency, the controller 12 may generate the route information so that the extracted characteristics are included in the route information, as points on which the high-skilled drivers focus.

For the stop positions for the delivery vehicle, the controller 12 may extract in advance possible stop positions for the delivery vehicle and calculate the delivery efficiency when the delivery vehicle is stopped at each of the extracted positions. For each stop position, the controller 12 may determine that the delivery efficiency is low when stopping of the delivery vehicle causes a nuisance to a surrounding area. The controller 12 may determine that, for example, when the delivery vehicle is stopped at a certain position, the delivery efficiency of stopping the delivery vehicle at the position is low in a case in which the vehicle is likely to be honked at or receive complaints from surrounding passing vehicles or passersby.

The controller 12 may extract combinations of routes or stop positions that have high delivery efficiency, from among travel routes or stop positions of multiple delivery vehicles. The controller 12 may calculate an evaluation value for delivery efficiency for each combination of the travel routes or the stop positions. The controller 12 may calculate the average of the evaluation values of the combinations. The controller 12 may select a combination to be presented to the driver, from among combinations that have the evaluation values higher than or equal to the average, and generate the combination as the route information. The controller 12 may generate the route information by selecting a combination suitable for the driver's skill, from among the combinations that have the evaluation values higher than or equal to the average.

<Output of Route Information>

The controller 12 may notify the driver of the generated route information. The controller 12 may output the route information through the interface 14 and notify the driver. The controller 12 may output the route information to the terminal apparatus 20. The terminal apparatus 20 may output the route information and notify the driver.

The controller 12 may determine not to notify the driver of the generated route information. The controller 12 may accept, from the driver, a designation whether to notify the driver of the generated route information. The controller 12 may accept, from the driver, a designation not to notify the driver of the generated route information. For example, the information processing apparatus 10 may accept, by the interface 14, an input that the driver designates the notification of the route information, or an input that the driver designates no notification of the route information. The terminal apparatus 20 may accept an input that the driver designates the notification of the route information, or an input that the driver designates no notification of the route information.

The controller 12 may determine to notify the driver of a part of items of the generated route information and not to notify the driver of the other items. The controller 12 may accept, from the driver, an input designating items to be notified to the driver or items not to be notified to the driver. The controller 12 may determine, for example, to notify the driver of the route for the delivery vehicle but not to notify the driver of the stop positions. On the contrary, the controller 12 may determine to notify the driver of the stop positions for the delivery vehicle but not to notify the driver of the route. The controller 12 may determine to notify the route for the delivery vehicle, but not to notify the selection of a lane in which the delivery vehicle travels or the timing of changing lanes.

The experienced or high-skilled drivers may find the notification of at least a part of items of the route information annoying. Since the driver can designate the notification of at least a part of the items of the route information, the driver's annoyance can be reduced. In addition, the low-skilled drivers may not fully understand the notified route information or may not be able to concentrate on driving due to the notification of the route information. Since the driver can designate the notification of at least a part of the items of the route information, the driver's driving is less likely to be interrupted. As a result, the convenience of the drivers can be enhanced. In addition, the overall efficiency of the delivery work can be increased.

### Example Procedure for Information Processing Method

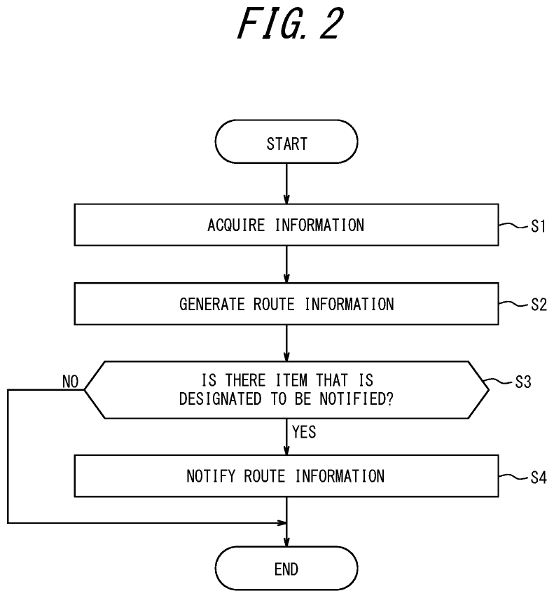

The controller 12 of the information processing apparatus 10 may perform an information processing method including a procedure of the flowchart in FIG. 2, for example, to generate the route information that indicates, to the driver, the route or the stop positions for the delivery vehicle. The information processing method may be implemented as an information processing program to be executed by the controller 12. The information processing program may be stored on a non-transitory computer readable medium.

The controller 12 acquires information such as driver information and delivery information on a delivery vehicle (step S1). The controller 12 generates route information for the delivery vehicle based on the driver information and the delivery information on the delivery vehicle (step S2). The controller 12 determines whether there is an item that is designated to be notified to a driver of the delivery vehicle, among items of the route information for the delivery vehicle (step S3). When there is no item that is designated to be notified (step S3: NO), the controller 12 ends the execution of the procedure of the flowchart in FIG. 2. When there is an item that is designated to be notified (step S3: YES), the controller 12 notifies the driver of the designated item of the route information (step S4). After performing the process of step S4, the controller 12 ends the execution of the procedure of the flowchart in FIG. 2.

### SUMMARY

As described above, the controller 12 of the information processing apparatus 10 generates the route information that indicates the route or the stop positions for the delivery vehicle based on the driver information and the delivery information on the delivery vehicle. The controller 12 thereby can provide the route information suitable for the driver of the delivery vehicle. By operating the delivery vehicle on the appropriate route, the travel of the vehicle 40 can be stabilized. The fuel efficiency of the vehicle 40 can be enhanced. The overall driving efficiency of the vehicle 40 can be enhanced. The delivery efficiency of the packages using the vehicle 40 can be enhanced. As a result, the overall efficiency of the delivery work can be increased.

While embodiments of the present disclosure have been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. An information processing method performed by an information processing apparatus, the information processing method comprising acquiring route information that indicates a route or a stop position for a delivery vehicle, the route information being generated based on driver information regarding a driver of the delivery vehicle and delivery information regarding a package to be delivered by the delivery vehicle.

2. The information processing method according to claim 1, wherein
the driver information includes a delivery work characteristic of the driver of the delivery vehicle, and
the information processing method further comprises calculating, as the delivery work characteristic of the driver of the delivery vehicle, a difference between an average work and a delivery work performance of the driver.

3. The information processing method according to claim 2, further comprising generating the route information so as to improve the delivery work characteristic of the driver of the delivery vehicle.

4. The information processing method according to claim 3, further comprising generating the route information so as to indicate a route or a stop position that reduces travel time of the delivery vehicle among routes that the driver of the delivery vehicle can drive, or to indicate a route or a stop position that provides experience to increase a number of routes that the driver of the delivery vehicle can drive.

5. The information processing method according to claim 1, further comprising accepting, from the driver of the delivery vehicle, a designation to notify the driver of the delivery vehicle of at least a part of items of the route information or a designation not to notify the driver of the delivery vehicle of at least a part of the items of the route information.

6. The information processing method according to claim 2, further comprising accepting, from the driver of the delivery vehicle, a designation to notify the driver of the delivery vehicle of at least a part of items of the route information or a designation not to notify the driver of the delivery vehicle of at least a part of the items of the route information.

7. The information processing method according to claim 3, further comprising accepting, from the driver of the delivery vehicle, a designation to notify the driver of the delivery vehicle of at least a part of items of the route information or a designation not to notify the driver of the delivery vehicle of at least a part of the items of the route information.

8. The information processing method according to claim 4, further comprising accepting, from the driver of the delivery vehicle, a designation to notify the driver of the delivery vehicle of at least a part of items of the route information or a designation not to notify the driver of the delivery vehicle of at least a part of the items of the route information.
